(19) United States
(12) Patent Application Publication
(10) Pub. No.: US 2010/0201636 A1
(43) Pub. Date: Aug. 12, 2010

(54) MULTI-MODE DIGITAL GRAPHICS AUTHORING

(75) Inventor: Erez Kikin-Gil, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/369,370

(22) Filed: Feb. 11, 2009

(51) Int. Cl. G06F 3/041

(52) U.S. Cl. 345/173

(57) ABSTRACT

Various embodiments related to the presentation of a multi-mode digital graphics authoring program are disclosed herein. One embodiment provides a computing device comprising a multi-touch display, a processor and memory comprising instructions executable by the processor to detect an initial touch of a physical object on the display, to display a workspace border defining a bounded workspace, to display a contextual menu associated with the bounded workspace, and to receive a touch input requesting an application setting selected from the contextual menu to be applied within the workspace border. The instructions are further executable to detect a subsequent touch within the workspace border, and, in response, to apply the application setting to the subsequent touch detected within the workspace border, to detect a subsequent touch outside of the workspace border, and, in response, not to apply the application setting to the subsequent touch detected outside of the workspace border.

### BACKGROUND

Touch-sensitive displays are configured to accept inputs in the form of touches, and in some cases near-touches, of objects on a surface of the display. Touch-sensitive displays may use various mechanisms to detect touches, including but not limited to optical, resistive, and capacitive mechanisms. Further, some touch-sensitive displays may be configured to detect a plurality of temporally overlapping touches. These displays, which may be referred to as multi-touch displays, may allow for a greater range of input touches and gestures than a display configured to accept a single touch at a time. In some use environments, two or more users may make temporally overlapping touches on a single multi-touch display. Further, in some cases, such users may interact with the same application.

### SUMMARY

Various embodiments related to the presentation of a multi-mode digital graphics authoring program are disclosed herein. For example, one disclosed embodiment provides a computing device comprising a multi-touch display, a processor and memory comprising instructions executable by the processor to detect an initial touch of a physical object on the display, and in response, display on the display a workspace border defining a bounded workspace associated with the physical object. The instructions are further executable to display on the display a contextual menu associated with the bounded workspace and to receive a touch input requesting an application setting selected from the contextual menu to be applied within the workspace border. The instructions are further executable to detect a subsequent touch within the workspace border and, in response, apply the application setting to the subsequent touch detected within the workspace border. Additionally, the instructions are executable to detect a subsequent touch outside of the workspace border, and not to apply the application setting to the subsequent touch detected outside of the workspace border.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of two users interacting with a multi-touch display via a multi-mode digital graphics authoring program.

FIG. 2 shows a flow diagram of an embodiment of a method of a multi-mode digital graphics authoring program on a computing device comprising a multi-touch display.

FIG. 3 shows a schematic depiction of a user interacting with a touch display via a multi-mode digital graphics authoring program in accordance with an embodiment of the present disclosure.

FIG. 4 shows the display of a workspace border defining a bounded workspace on the embodiment of FIG. 3.

FIG. 5 shows the display of a contextual menu associated with the bounded workspace of the embodiment of FIG. 3.

FIG. 6 shows a schematic depiction of a bounded workspace moving in accordance with a movement of a touch on the embodiment of FIG. 3.

FIG. 7 shows a schematic depiction of two users interacting with a touch display via a multi-mode digital graphics authoring program in accordance with another embodiment of the present disclosure.

FIG. 8 shows the display of a second workspace border defining a second bounded workspace, and a second contextual menu, in response to a second touch on the embodiment of FIG. 7.

FIG. 9 shows a schematic depiction of two users interacting with a touch display via a multi-mode digital graphics authoring program in accordance with another embodiment of the present disclosure.

FIG. 10 shows the application of settings within a workspace border to a subsequent touch detected within the workspace border of the embodiment of FIG. 9.

FIG. 11 shows a time-sequenced schematic depiction of a user interacting with a touch display via a multi-mode digital graphics authoring program in accordance with another embodiment of the present disclosure.

FIG. 12 shows a time-sequenced schematic depiction of a user interacting with a touch display via a multi-mode digital graphics authoring program in accordance with another embodiment of the present disclosure.

FIG. 13 shows a schematic depiction of an embodiment of an interactive display device.

### DETAILED DESCRIPTION

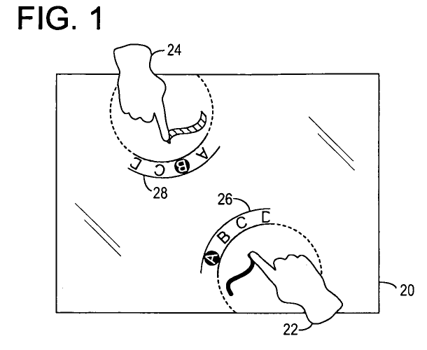

FIG. 1 shows a schematic depiction of two users interacting with a multi-touch display 20 via a multi-mode digital graphics authoring program. As depicted, user 22 and user 24 may both interact with multi-touch display 20 via a multi-mode digital graphics authoring program, such as a multi-mode painting program. The term “multi-mode” as used herein indicates that two users may use the application program in two different areas of the display while each using a different painting mode (e.g. color, brush, fill pattern, etc.). For example, user 22 may select an application setting from a first contextual menu 26 associated with the touch of user 22, and user 24 may select application settings from a second contextual menu 28 associated with the touch of user 24, wherein the application settings may be different. As depicted, user 22 has selected an example setting “A” of a solid paintbrush, and user 24 has selected an example setting “B” of a patterned paintbrush.

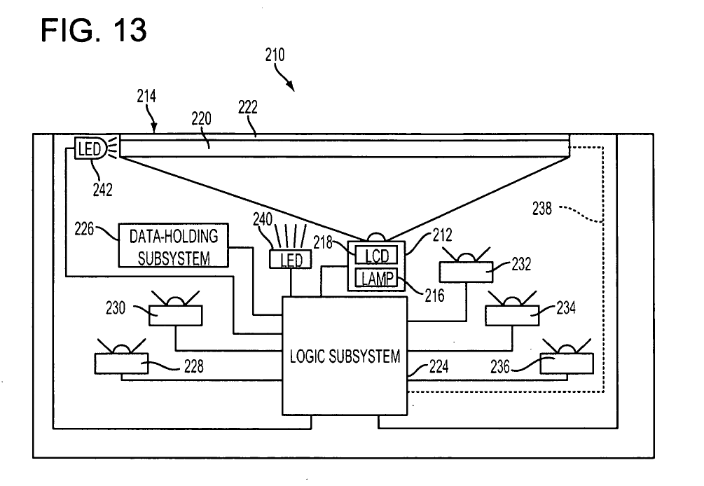

It will be understood that multi-touch display 20 may utilize any suitable touch-sensing mechanism, including but not limited to optical, capacitive, resistive, etc. One embodiment of a suitable multi-touch display device is described below with reference to FIG. 13.

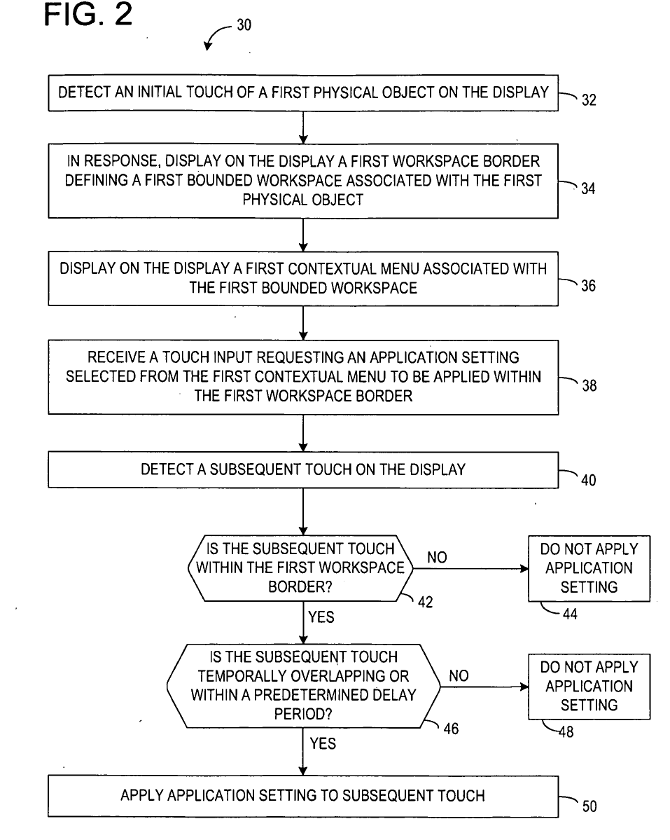

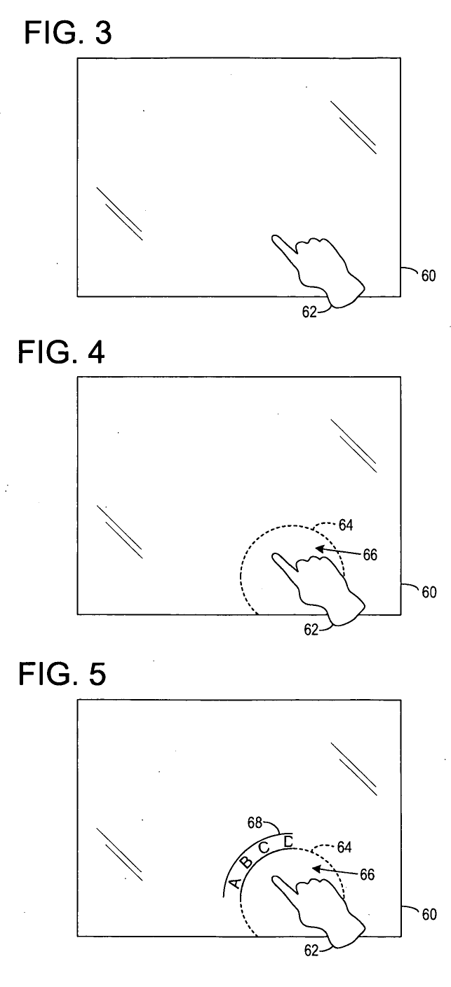

FIG. 2 illustrates a flow diagram of an embodiment of a method 30 of operating a multi-mode digital graphics authoring program on a computing device comprising a multi-touch display. At 32 method 30 includes detecting an initial touch of a first physical object on the display. Such an object may be a finger of the user of the display, a stylus, or any other such physical object with which the user interacts with the display. As an example, FIG. 3 shows a display 60 detecting an initial touch of user 62.

The term “initial touch” as used herein refers to a touch configured to open a first workspace border. Therefore, returning to FIG. 2, in response to detecting the initial touch of the first physical object on the display, at 34 method 30 includes displaying on the display a first workspace border. The first workspace border defines a first bounded workspace associated with the first physical object, where the first bounded workspace defines a bounded area of the display. Such a bounded workspace may be of any suitable shape and/or size, comprising a portion of the display. As an example, FIG. 4 shows a display 60 displaying a workspace border 64 defining a bounded workspace 66, in response to detecting a touch of user 62.

Returning to FIG. 2, at 36 method 30 includes displaying on the display a first contextual menu associated with the first bounded workspace. Such a menu may be displayed for the user near the first bounded workspace. The user may then select one or more application settings from the contextual menu, such that the settings will be applied to subsequent touches detected within the first workspace border, as described in more detail as follows. As an example, FIG. 5 shows a display 60 displaying a contextual menu 68 associated with the bounded workspace 66. As depicted, contextual menu 68 displays four selectable application settings, namely “A,” “B,” “C” and “D.” However, it is to be understood that contextual menu 68 is exemplary in that a contextual menu may display fewer options or more options, in any suitable configuration.

Returning to FIG. 2, at 38 method 30 includes receiving a touch input requesting an application setting selected from the first contextual menu to be applied within the first workspace border. For example with reference to FIG. 5, user 62 may select one or more settings “A,” “B,” “C” and “D” to be applied to subsequent touches detected within bounded workspace 66 defined by workspace border 64. In the context of a painting program described above, such settings may include brush styles, color options, formatting options, etc. It is to be understood that virtually any number of settings may be included in the contextual menu, such as editing options, viewing preferences, printing preferences, etc.

Thus, as described above, in some embodiments of method 30, upon defining the bounded workspace, method 30 includes waiting for the touch input requesting the application setting before enabling a display response to a touch gesture made within the workspace border. In other embodiments, method 30 may include a default setting such that upon defining the bounded workspace, method 30 may include applying a default application setting to a touch gesture made within the bounded workspace.

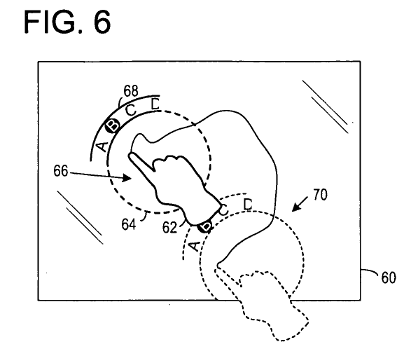

In some embodiments, method 30 may include detecting a change in a location of the initial touch of the first physical object on the display. In response, method 30 may further include adjusting a location of the workspace border in response to detecting the change in the location of the initial touch of the first physical object. For example, if the user is drawing, the touch display may detect the change in location of the touch of the user's finger while drawing. Upon detecting this change, the display may adjust the location of the workspace border to track the finger that is drawing. Thus, the bounded workspace remains associated with the finger, and the workspace border indicates that the bounded workspace is moving in synchronous with the finger. In such a case, settings of a contextual menu associated with the bounded workspace may continually be applied within the workspace border. As an example, FIG. 6 shows a user 62 interacting with a touch display 60 via a drawing program. As shown, display 60 displays a workspace border 64 defining a bounded workspace 66, and displays contextual menu 68, as indicated in bold line, associated with the user's touch. Upon commencing drawing as indicated in dashed-line at 70, display 60 detects the change in location of the user's touch, and in response, adjusts the locations of the workspace border 64 and contextual menu 68 associated with the user's touch. Thus, the workspace border 64 and contextual menu 68 track the user's touch.

Returning to FIG. 2, at 40 method 30 includes detecting a subsequent touch on the display. In some cases, the subsequent touch may originate from the same user, for example, from a same finger or a different finger of the user. In other cases, the touch may originate from another physical object such as another user, such that the initial touch of the first physical object is associated with a first user, and the subsequent touch is associated with a second user.

Further, in some cases, the initial touch of the first physical object on the display may temporally overlap with the subsequent touch on the display. In other words, the first physical object may still be touching the display when the subsequent touch touches the display. In other embodiments, the initial touch of the first physical object on the display and the subsequent touch on the display are temporally separated. In other words, the initial touch of the first physical object is lifted before the subsequent touch is detected on the display.

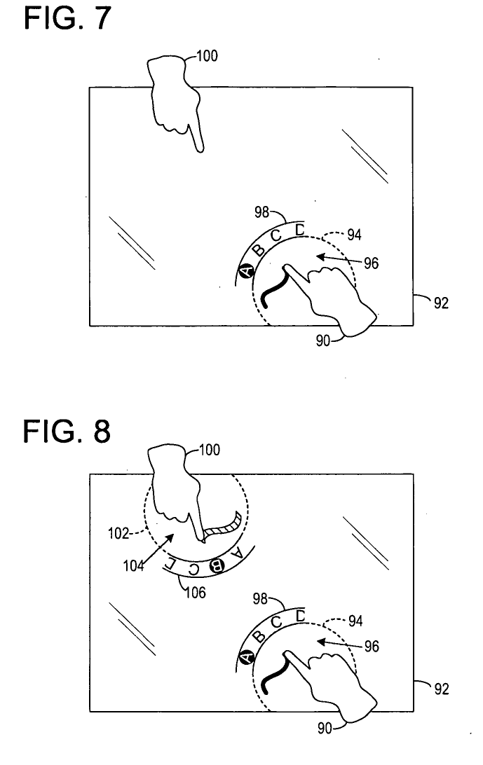

Continuing with FIG. 2, upon detecting the subsequent touch on the display, at 42 method 30 includes determining if the subsequent touch is within the first workspace border. If it is determined that the subsequent touch is not within the first workspace border, then at 44 method 30 includes not applying the application setting to the subsequent touch. As an example, FIG. 7 shows a user 90 interacting with a touch display 92 via a drawing program. As shown, display 92 displays a workspace border 94 defining a bounded workspace 96 and a contextual menu 98 in response to the touch of user 90, and the user has selected an application setting “A” of a solid paintbrush. Display 92 may then detect a subsequent touch, for example of user 100, and determine that the touch of user 100 is outside of workspace border 94. In response, the display does not apply application setting “A” to the touch of user 100. In some cases, display 92 may then display a second workspace border 102 defining a second bounded workspace 104, and a contextual menu 106 as depicted in FIG. 8. In such a case, the second bounded workspace 104 is associated with the touch of user 100. Accordingly, user 100 may select an application setting to be applied to subsequent touches detected within the second workspace border 102, such as setting “B” of a striped paintbrush, as depicted in FIG. 8.

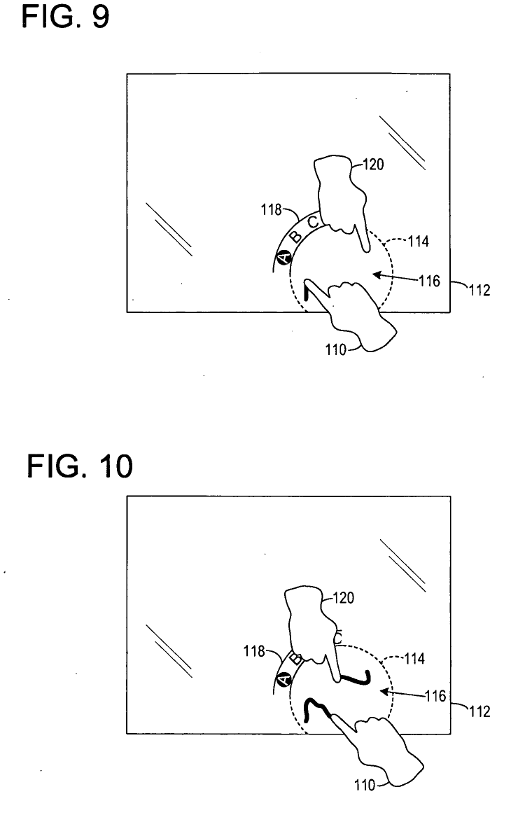

Returning to FIG. 2, if it is determined that the subsequent touch is within the workspace border, then at 50 method 30 includes applying the application setting to the subsequent touch. As an example, FIG. 9 shows a user 110 interacting with a touch display 112 via a drawing program. As shown, display 112 displays a workspace border 114 defining a bounded workspace 116, and contextual menu 118 in response to the touch of user 110, and the user has selected an application setting “A” of a solid paintbrush. Display 112 may then detect a subsequent touch, for example of user 120, and determine that the touch of user 120 is within workspace border 114. In response, the display may apply application setting “A” to the touch of user 120, as shown in FIG. 10.

Returning to FIG. 2, in some embodiments of method 30, upon determining at 42 that the subsequent touch is within the workspace border, then at 46 method 30 may include determining if the touch is temporally overlapping or within a predetermined delay period. For example, if the initial touch of the first physical object was not lifted before the subsequent touch was detected, then the subsequent touch is temporally overlapping. Alternatively, if the initial touch of the first physical object was lifted before the subsequent touch was detected, then the subsequent touch may or may not be detected within a predetermined delay period. For example, the predetermined delay period may define a time limit such that touches detected within the predetermined delay period may be considered to be occurring during a same drawing session, and therefore the same application setting may be applied. Alternatively, touches detected outside of the predetermined delay period may be considered to be occurring during a new drawing session, and therefore the same application setting may not be automatically applied.

First, if the subsequent touch is temporally overlapping with the initial touch of the first physical object, then at 50 method 30 includes applying the application setting to the subsequent touch. FIGS. 9 and 10 illustrate such a case when the touch of user 120 is detected while user 110 is touching display 1 12.

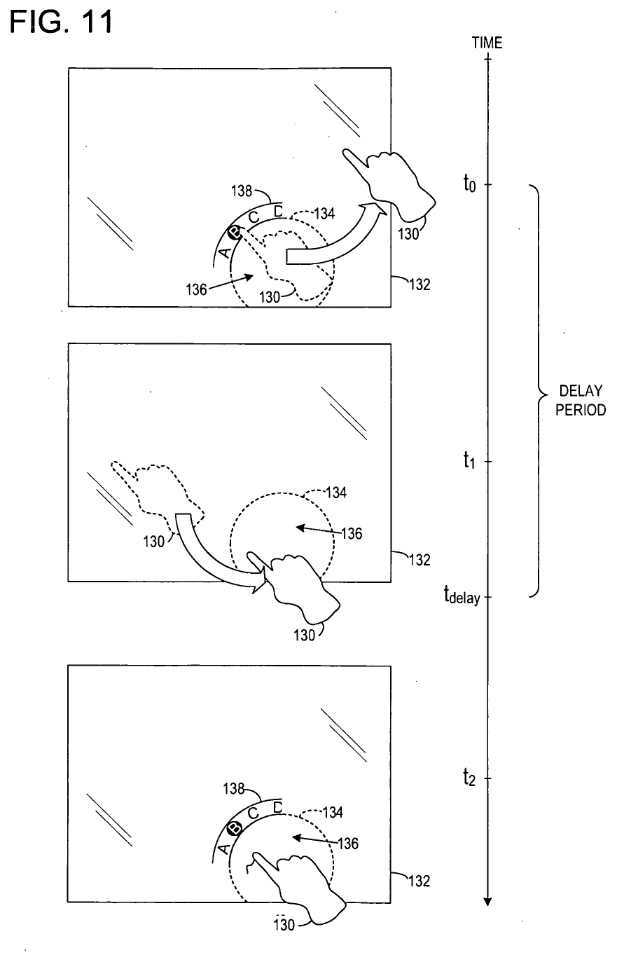

Next, if the touches are not temporally overlapping but it is determined at 46 that the subsequent touch is within the predetermined delay period, then at 50 method 30 includes applying the application setting to the subsequent touch. As an example, FIG. 11 shows a nonlimiting example of a user 130 interacting with a touch display 132 via a drawing program, where in response to detecting a first touch of user 130, display 132 has displayed a workspace border 134 defining a bounded workspace 136, and displayed a contextual menu 138. As depicted at time t₀, user 130 may select an application setting, for example, setting “B” of contextual menu 138, to be applied to subsequent touches detected within the workspace. Next, at a later time t₁, display 132 may detect a subsequent touch within workspace border 134. Display 132 may determine that the touch detected at time t₁ occurred within a predetermined delay period of the first touch. Accordingly, display 132 may then apply the application setting “B” to the touch detected at time t₁, as shown at time t₂.

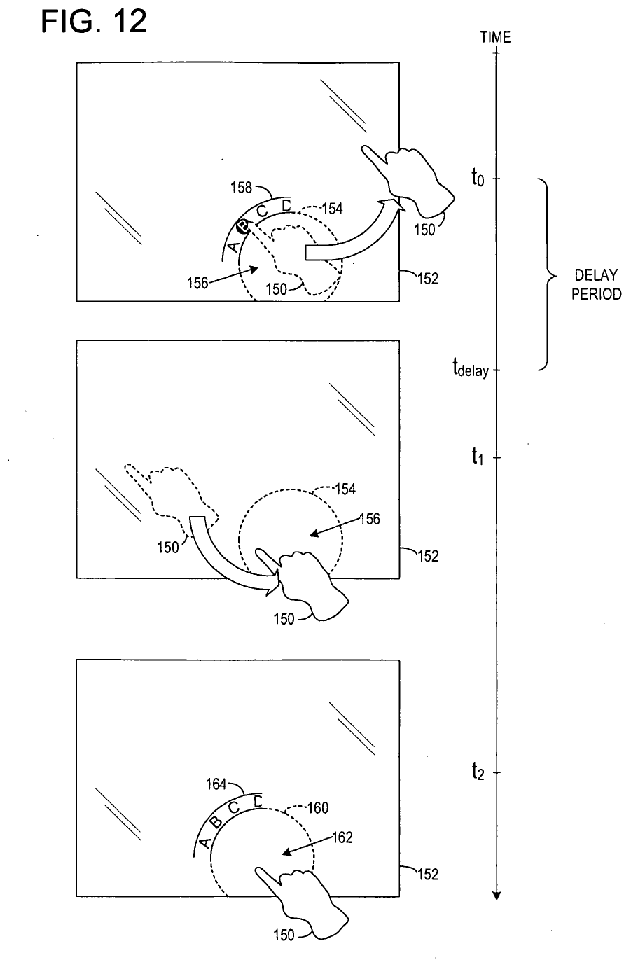

On the other hand, if it is determined at 46 that the subsequent touch is outside of the predetermined delay period, then at 48 method 30 includes not applying the application setting to the subsequent touch. As an example, FIG. 12 shows a nonlimiting example of a user 150 interacting with a touch display 152 via a drawing program, where in response to detecting a first touch of user 150, display 152 has displayed a workspace border 154 defining a bounded workspace 156, and displayed a contextual menu 158. As depicted at time t₀, user 150 may select an application setting, for example, setting “B” of contextual menu 158, to be applied to subsequent touches detected within the workspace. Next, at a later time t₁, display 152 may detect a subsequent touch within workspace border 154. Display 152 may determine that the touch detected at time t₁ occurred outside of a predetermined delay period of the first touch. Accordingly, display 152 may not apply the application setting “B” to the touch detected at time t₁. Rather, display 152 may display a new workspace border 160 defining a new bounded workspace 162, and display a contextual menu 164, as shown at time t₂.

Returning to FIG. 2, in some embodiments, method 30 may further include detecting cessation of the initial touch of the first physical object, and in response, displaying on the display a fading of the workspace border of the bounded workspace associated with the physical object. It is to be understood that such a fading of the workspace border is exemplary in that the display may cease displaying of the border in virtually any manner, such as by quickly fading the border, slowly fading the border, abruptly removing the border without fading, etc.

Further, in some embodiments, method 30 may include detecting cessation of the initial touch of the first physical object, and in response, cease displaying of the workspace border after passage of a predetermined time period. As an example, the predetermined time period may be two seconds, such that upon detecting a lifting of the touch, the workspace border is removed from the display after two seconds. It is to be understood that the predetermined time period may be any suitable time period, and the above example is not intended to be limiting in any manner.

The above described embodiments may be implemented in any suitable computing device. For example, in one embodiment, the above described embodiments may be implemented in an interactive display device in the form of a surface computing system. As an example, FIG. 13 shows a schematic depiction of an embodiment of a surface computing system 210. The surface computing system 210 comprises a projection display system having an image source 212, and a display screen 214 onto which images are projected. Image source 212 may be a rear projector that can project images onto display screen 214. Image source 212 may comprise a light source 216, such as the depicted wideband source arc lamp 216, a plurality of LEDs configured to emit light of three colors (e.g. three primary colors), and/or any other suitable light source. Image source 212 may also comprise an image-producing element 218, such as the depicted LCD (liquid crystal display), an LCOS (liquid crystal on silicon) display, a DLP (digital light processing) display, or any other suitable image-producing element.

Display screen 214 may include a clear, transparent portion 220, such as a sheet of glass, and a diffuser, referred to herein as diffuser screen layer 222, disposed over the clear, transparent portion 220. In some embodiments, an additional transparent layer (not shown) may be disposed over diffuser screen layer 222 to provide a smooth look and feel to the display screen. In this way, transparent portion 220 and diffuser screen layer 222 can form a non-limiting example of a touch-sensitive region of display screen 214. It will be understood that the diffuser screen layer may either be a separate part from the clear, transparent portion 220, or may be formed in a surface of, or otherwise integrated with, the clear, transparent portion 220.

Continuing with FIG. 13, surface computing system 210 may further includes a logic subsystem 224 and data holding subsystem 226 operatively coupled to the logic subsystem 224. The surface computing system 210 may include a user input device (not shown), such as a wireless transmitter and receiver configured to communicate with other devices.

To sense objects that are contacting or near to display screen 214, surface computing system 210 may include one or more image capture devices (e.g., sensor 228, sensor 230, sensor 232, sensor 234, and sensor 236) configured to capture an image of the backside of display screen 214, and to provide the image to logic subsystem 224. The diffuser screen layer 222 can serve to reduce or avoid the imaging of objects that are not in contact with or positioned within a few millimeters or other suitable distance of display screen 214, and therefore helps to ensure that at least objects that are touching the display screen 214 are detected by the image capture devices. While the disclosed embodiments are described in the context of a vision-based multi-touch display system, it will be understood that the embodiments may be implemented on any other suitable touch-sensitive display system, including but not limited to capacitive and resistive systems.

The image capture devices may include any suitable image sensing mechanism. Examples of suitable image sensing mechanisms include but are not limited to CCD and CMOS image sensors. Further, the image sensing mechanisms may capture images of the display screen 214 at a sufficient frequency or frame rate to detect motion of an object across the display screen 214. In other embodiments, a scanning laser may be used in combination with a suitable photodetector to acquire images of the display screen 214. Display screen 214 may alternatively or further include an optional capacitive, resistive or other electromagnetic touch-sensing mechanism, which may communicate touch input to the logic subsystem via a wired or wireless connection 238.

The image capture devices may be configured to detect reflected or emitted energy of any suitable wavelength, including but not limited to infrared and visible wavelengths. To assist in detecting objects placed on display screen 214, the image capture devices may further include an illuminant, such as one or more light emitting diodes (LEDs). FIG. 13 shows an infrared light source 240 and an infrared light source 242 configured to produce infrared light. Light from the illuminant may be reflected by objects contacting or near display screen 214 and then detected by the image capture devices. The use of infrared LEDs as opposed to visible LEDs may help to avoid washing out the appearance of projected images on display screen 214.

In some examples, one or more of infrared light source 240 and/or infrared light source 242 may be positioned at any suitable location within surface computing system 210. In the example of FIG. 13, an infrared light source 242 may be placed along a side of display screen 214. In this location, light from the infrared light source can travel through display screen 214 via internal reflection, while some light can escape from display screen 214 for reflection by an object on the display screen 214. In other examples, an infrared light source 240 may be placed beneath display screen 214.

It will be understood that the surface computing system 210 may be used to detect any suitable physical object, including but not limited to, fingers, styluses, cell phones, cameras, other portable electronic consumer devices, barcodes and other optically readable tags, etc.

It will be appreciated that the embodiments disclosed herein may be implemented in any other suitable computing devices configured to execute the programs described herein. For example, the computing devices may be a mainframe computer, personal computer, laptop computer, portable data assistant (PDA), computer-enabled wireless telephone, networked computing device, or other suitable computing device. Such computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computing device, comprising:
a multi-touch display;
a processor; and
memory comprising instructions executable by the processor to:
detect an initial touch of a physical object on the display;
in response, display on the display a workspace border defining a bounded workspace associated with the physical object, the bounded workspace defining a bounded area of the display;
display on the display a contextual menu associated with the bounded workspace;
receive a touch input requesting an application setting selected from the contextual menu to be applied within the workspace border;
detect a subsequent touch within the workspace border and, in response, apply the application setting to the subsequent touch detected within the workspace border; and
detect a subsequent touch outside of the workspace border and, in response, not to apply the application setting to the subsequent touch detected outside of the workspace border.

2. The device of claim 1, wherein the physical object is a finger of a user of the display.

3. The device of claim 1, wherein the instructions are further executable to detect a change in a location of the physical object, and in response, to adjust a location of the workspace border.

4. The device of claim 1, wherein the instructions are further executable, upon defining the bounded workspace, to wait for the touch input requesting the application setting before enabling a display response to a touch gesture made within the workspace border.

5. The device of claim 1, wherein the instructions are further executable, upon defining the bounded workspace, to apply a default application setting to a touch gesture made within the bounded workspace.

6. The device of claim 1, wherein the instructions are further executable to detect a lifting of the initial touch, to detect the subsequent touch within the workspace border before passage of a predetermined delay period, and to apply the application setting to the subsequent touch detected within the workspace border.

7. The device of claim 1, wherein the instructions are further executable to detect a lifting of the initial touch, to detect the subsequent touch within the workspace border after passage of a predetermined delay period, and not apply the application setting to the subsequent touch detected within the workspace border.

8. The device of claim 1, wherein the instructions are further executable to detect cessation of the initial touch of the physical object, and in response, display on the display a fading of the workspace border of the bounded workspace associated with the physical object.

9. The device of claim 8, wherein the instructions are further executable to detect cessation of the initial touch of the physical object, and in response, cease display of the workspace border after passage of a predetermined time period.

10. A method of operating a multi-mode digital graphics authoring program on a computing device comprising a multi-touch display, the method comprising:
detecting an initial touch of a first physical object on the display;
in response, displaying on the display a first workspace border defining a first bounded workspace associated with the first physical object, the first bounded workspace defining a bounded area of the display;
displaying on the display a first contextual menu associated with the first bounded workspace;
receiving a touch input requesting an application setting selected from the first contextual menu to be applied within the first workspace border;
detecting a subsequent touch on the display;
determining if the subsequent touch is detected at a location outside of the first workspace border;
if the subsequent touch is detected at a location outside of the first workspace border, then, in response to detecting the subsequent touch on the display, displaying on the display a second workspace border defining a second bounded workspace associated with the subsequent touch; and
if the subsequent touch is detected at a location within the first workspace border, applying the application setting to the subsequent touch.

11. The method of claim 10, further comprising detecting a change in a location of the first physical object, and in response, adjusting a location of the first workspace border.

12. The method of claim 10, wherein the multi-mode digital graphics authoring program is a painting program.

13. The method of claim 10, wherein the initial touch of the first physical object on the display temporally overlaps with the subsequent touch detected on the display.

14. The method of claim 10, wherein the initial touch of the first physical object is lifted before detecting the subsequent touch on the display.

15. The method of claim 14, further comprising detecting the subsequent touch on the display at a location within the first workspace border within a predetermined delay period, and applying the application setting to the subsequent touch.

16. The method of claim 14, further comprising detecting the subsequent touch on the display at a location within the first workspace border outside of a predetermined delay period, and not applying the application setting to the subsequent touch.

17. A computer-readable medium comprising instructions stored thereon that are executable by a computing device comprising a multi-touch display to perform a method of operating a multi-mode digital graphics authoring program, the method comprising:
detecting an initial touch of a first physical object on the display;
in response, displaying on the display a first workspace border defining a first bounded workspace associated with the first physical object, the first bounded workspace defining a bounded area of the display;
displaying on the display a first contextual menu associated with the first bounded workspace;
receiving a touch input requesting an application setting selected from the first contextual menu to be applied within the first workspace border;
detecting a change in a location of the initial touch of the first physical object on the display;
adjusting a location of the first workspace border in response to detecting the change in the location of the initial touch of the first physical object;
detecting a subsequent touch on the display;
determining if the subsequent touch is detected at a location outside of the first workspace border;
if the subsequent touch is detected at a location outside of the first workspace border, then, in response to detecting the subsequent touch on the display, displaying on the display a second workspace border defining a second bounded workspace associated with the subsequent touch; and
if the subsequent touch is detected at a location within the first workspace border, applying the application setting to the subsequent touch.

18. The computer readable medium of claim 17, wherein detecting the subsequent touch on the display comprises detecting a subsequent touch that is temporally overlapping with the initial touch of the first physical object.

19. The computer readable medium of claim 17, wherein detecting the subsequent touch on the display comprises detecting a subsequent touch that is temporally separated from the initial touch of the first physical object.

20. The computer readable medium of claim 19, wherein, if the subsequent touch on the display is detected at a location within the first workspace border but outside of a predetermined delay period, then the method further comprises not applying the application setting to the subsequent touch.
